(19) United States
(12) Patent Application Publication
(10) Pub. No.: US 2009/0145267 A1
(43) Pub. Date: Jun. 11, 2009

(54) Screw-Off Top Extractor

(76) Inventor: Joao Carlos Moles, Goiania- Goias (BR)

Correspondence Address: FURR LAW FIRM, 2622 DEBOLT ROAD, UTICA, OH, 43080, US

(21) Appl. No.: 10/596,698

(22) PCT Filed: Dec. 22, 2004
(86) PCT No.: PCT/BR04/00256

§ 371 Date: Jun. 21, 2006

(30) Foreign Application Priority Data
Dec. 22, 2003 (BR) PI 0306409.3

(51) Int. Cl. B67B 7/62

(52) U.S. Cl. 81/3.37

(57) ABSTRACT

‘SCREW-OFF TOP EXTRACTOR’ refers to the present extractor as a piece manufactured with disposable and low cost materials, to be placed on bottle-necks of screw-on beverages bottles, with screw threads on the bottle neck; this extractor has internal slits (02) to incase in the external slits of the tops and facilitate the unscrewing of the top of the beverage bottle. The present extractor internal wall is made from top to bottom in a conical form (03) permitting a sure fitting on the bottle neck.

### SUMMARY OF INVENTION

‘SCREW-OFF TOP EXTRACTOR’ refers to the present extractor as a piece manufactured with disposable and low cost materials, to be placed on bottle-necks of screw-on beverages bottles, with screw threads on the bottle neck; this extractor has internal slits (02) to incase in the external slits of the tops and facilitate the unscrewing of the top of the beverage bottle. The present extractor internal wall is made from top to bottom in a conical form (03) permitting a sure fitting on the bottle neck.

### BRIEF DESCRIPTION OF DRAWINGS

Without restricting the full scope of this invention, the preferred form of this invention is illustrated in the following drawings:

FIG. 1 shows a top view of the extractor;

FIG. 2 shows a view of the bottom of the extractor;

FIG. 3 shows a lateral view in perspective of—the extractor;

FIG. 4 shows the extractor from a lateral-top view;

FIG. 5 shows the extractor from a lateral bottom;

FIG. 6 shows, in an enlarged view, an illustration of a bottle with the screw threads on the neck, an extractor, and the top;

FIG. 7 shows an illustration of a bottle with the extractor on the bottleneck and the screw on top above the bottle;

FIG. 8 shows the same illustration seen in FIG. 7 but, now with the top already screwed on, and the extractor below the top and fixed to the bottleneck;

FIG. 9 shows an illustration of the extractor when it is raised into the position where its' internal slits fit into the external slits of the bottle top; and

FIG. 10 shows an illustration of the rotation used to unscrew the bottle top pushing the extractor upward in order to facilitate the opening of the bottle; both the top and extractor can then be discarded.

Descriptive report on the patent: invention of the “SCREW-OFF TOP EXTRACTOR”.

This invention refers to a piece that can be manufactured in a hexagonal format, or even in cylinder form, using disposable and low cost materials. It is meant to be used on the neck of beverage bottles with screw-on tops.

The tops used to seal beverage bottles present external slits made by the equipment used to seal these bottles. For this reason, the screw-on type bottles, created to facilitate their opening, end up presenting some inconveniences, such as: the top must be submitted to great pressure at the time of capping, and therefore will require lots of physical force in order to unscrew; also, due to the external slits in such tops, many times the person may injure his or her hands attempting to open them; furthermore, when the person is unable to unscrew the top with their bare hands they may end up using the edge of their shirt or T-shirt while attempting to unscrew the top and end up damaging their clothing, therefore generating financial loss.

Trying to find a solution to these problems the present invention of the “SCREW-OFF TOP EXTRACTOR” was developed. It can be manufactured with disposable and low cost materials, which can be presented—externally in a hexagonal format to facilitate the torsion movement of unscrewing the top from the bottle, or even in other outer formats, like a cylindrical form for example.

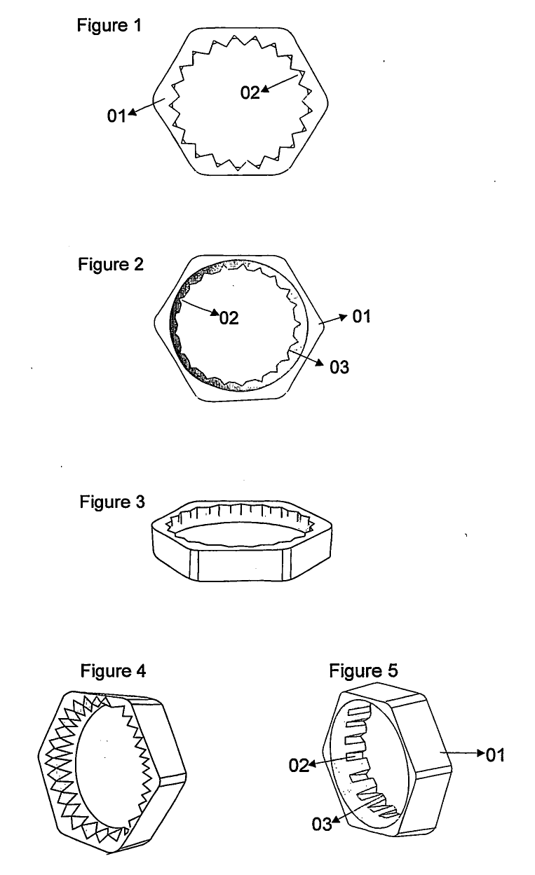

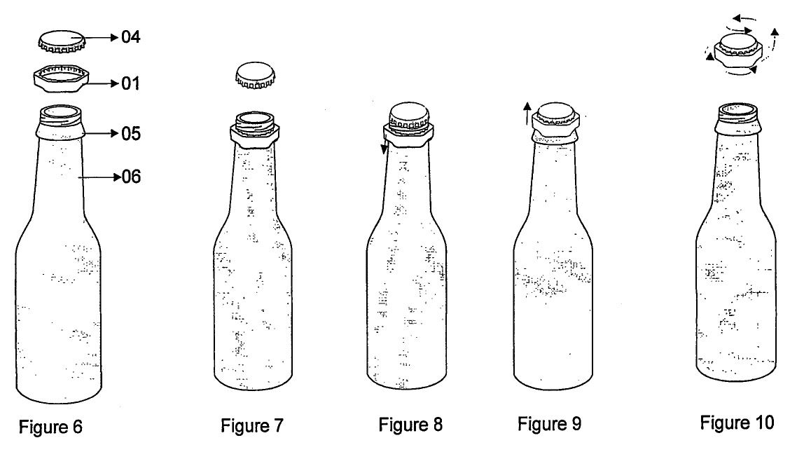

The drawings attached show with precision the manufacturability and functional disposition applied in this “SCREW-OFF TOP where: FIG. 1 shows a top view of the extractor; FIG. 2 shows a view of the bottom of the extractor; FIG. 3 shows a lateral view in perspective of—the extractor; FIG. 4 shows the extractor from a lateral-top view; FIG. 5 shows the extractor from a lateral bottom; FIG. 6 shows, in an enlarged view, an illustration of a bottle with the screw threads on the neck, an extractor, and the top; FIG. 7 shows an illustration of a bottle with the extractor on the bottleneck and the screw on top above the bottle; FIG. 8 shows the same illustration seen in FIG. 7 but, now with the top already screwed on, and the extractor below the top and fixed to the bottleneck; FIG. 9 shows an illustration of the extractor when it is raised into the position where its' internal slits fit into the external slits of the bottle top; FIG. 10 shows an illustration of the rotation used to unscrew the bottle top pushing the extractor upward in order to facilitate the opening of the bottle; both the top and extractor can then be discarded.

As shown in the attached drawings, we have: The extractor (01) that has on its upper part the slits (02) and on the bottom part a conical form (03).

In this way, the extractor can be manufactured a conical internal opening (03) so that the upper side contains the slits (02) on the bottom, and the opening of the inferior part of the extractor (01) is larger than the upper opening that contains the slits (02) that will fit into the external slits on the bottle top (04).

The extractor (01) in conical form (03) from top to bottom will permit that once incased on the neck of the bottle (06) it will stay in place (05) ready to be pulled up and have its internal slits (02) incase into the external slits of the bottle top (04) and allow an easy opening of the pressure placed on the bottle top without traumas.

1. “SCREW-OFF TOP EXTRACTOR” is a new invention manufactured with disposable and low cost materials, which can have an external hexagonal or circular form characterized as an extractor (01) in conical form from top to bottom with a conical internal opening (03) that contains internal slits (02) on the upper side on the bottom of said extractor (01) which fit into the external slits on a bottle top (04).
